(19) United States
(12) Patent Application Publication
(10) Pub. No.: US 2008/0158422 A1
(43) Pub. Date: Jul. 3, 2008

(54) CIRCUIT, METHOD AND SYSTEM FOR DETERMINING VIDEO SIGNAL TYPE FOR GENERATION BY A MEDIA PLAYER

(75) Inventors: Johnson CHUA, Singapore (SG); Chin Fang LIM, Singapore (SG)

Correspondence Address: CREATIVE LABS, INC.;LEGAL DEPARTMENT, 1901 MCCARTHY BLVD, MILPITAS, CA, 95035, US

(73) Assignee: CREATIVE TECHNOLOGY LTD, Singapore (SG)

(21) Appl. No.: 11/619,586

(22) Filed: Jan. 3, 2007

(51) Int. Cl. H04N 5/46

(52) U.S. Cl. 348/558; 348/E05.114

(57) ABSTRACT

A circuit, method and system for determining which type of video signal is to be generated by a media player are described herein. In the described embodiment, the media player has three video ports for transferring different types of video signal with each type of video signal requiring a predetermined number of ports for transferring its video signals, for example s-video requires two video ports. To determine which type of signal to generate, the detection circuit comprises a detector arranged to detect which of the video ports have a load coupled thereto, and is further arranged to control the media player to generate the type of video signal according to the number of ports detected that is coupled with the load.

### FIELD OF THE INVENTION

The invention relates to a circuit, method and system for determining the type of video signal to be generated by a media player.

### BACKGROUND OF THE INVENTION

With the advent of more video technologies, different signal types are introduced and if a media player is to support different video signal types, for example, composite video, s-video and component video, then the number of video output ports of the media player are also increased correspondingly. For example, for composite video, one RCA cable connector is required to carry the composite video-in and another for composite video-out and thus two video output ports are required. If the media player supports the three video signal types mentioned above, then the media player requires twelve video ports, which increases the size of the media player and cost since more ports are required. Consequently, manufacturers have to obtain a balance between the number of different video formats that a player may support, a physical size of the player (form factor) and cost considerations.

An object of the present invention is to provide a circuit and method which addresses the disadvantages of the prior art and/or to provide a user with an alternative choice.

### SUMMARY OF THE INVENTION

According to a first aspect of the invention there is provided a circuit for determining which type of video signal is to be generated by a media player, the media player having a plurality of video ports for transferring different types of video signals, each type of video signal requiring a predetermined number of port(s) for transferring its video signals, the circuit comprising

a detector arranged to detect which of the video port(s) has a load coupled thereto, and is further arranged to control the media player to generate a said type of video signal according to the number of port(s) detected that is coupled with the load.

Since each type of video signal requires a predetermined number of ports for transferring its video signals (for example, a composite video, 1 port whereas s-video, 2 ports etc), an advantage of the described embodiment is that the detector can automatically determine which type of video signal is to be generated by detecting which of the video ports has a load coupled thereto.

In the described embodiment, the detector is arranged to detect connection of a cable connected to a display device to a video port as an indication that that video port has a load. Thus, a user does not need to manually select what type of video signal to be generated but merely couples the video cables to the ports for the media player to know what is to be generated.

Preferably, the detector comprises a plurality of voltage divider circuits with each divider circuit arranged to be coupled to a said video port to detect whether a load is coupled to a said video port. This provides a reliable and cost effective method to perform the detection.

The plurality of voltage divider circuits may be arranged to be coupled to GPIO ports of a video processor to control which type of video signal is to be generated.

In a second aspect, the invention also relates to a media player comprising a circuit as described above. Advantageously, such a media player is capable of generating at least two video signal types selected from composite video, s-video and component video. In this way, the media player can offer more functions and choices to the user, and only requires an optimum number of video ports to support all the different video signal types.

The invention is also concerned with a detection method which forms a third aspect and accordingly, there is provided a method of determining which type of video signals to be generated by a media player having a plurality of video ports for transferring different types of video signals, each type of video signal requiring a predetermined number of ports for transferring its video signals, the method comprising:

detecting the number of video ports that has a load coupled thereto; and controlling the media player to generate a said type of video signal according to the number of ports detected that is coupled with said load.

In the described embodiment, the video ports are shared between different video signal types whereas in the prior art, each video signal type has dedicated video ports and thus, in a fourth aspect of the invention, there is provided a media player capable of generating different video signal types, the media player comprising a plurality of video ports arranged to transfer the different types of video signals, each type of video signal requiring a predetermined number of ports for transferring its video signals, wherein at least one of the video port is arranged to selectively transfer two or more different video signal types.

A corresponding system for determining which type of video signal is to be generated by a media player is also described.

Features described in relation to one aspect of the invention may also be applicable to the other aspect of the invention.

### BRIEF DESCRIPTION OF THE DRAWINGS

An embodiment of the invention will now be described, by way of example, with reference to the accompanying drawings in which:

FIG. 1 is a block diagram of a video signal detector and a video processor of a portable media player;

FIG. 2 is a detailed circuitry of the video signal detector according to an embodiment of the invention; and

FIG. 3 is a flowchart of the detection steps carried out by the video detection circuit to determine which video signal type to output.

### DETAILED DESCRIPTION OF A PREFERRED EMBODIMENT

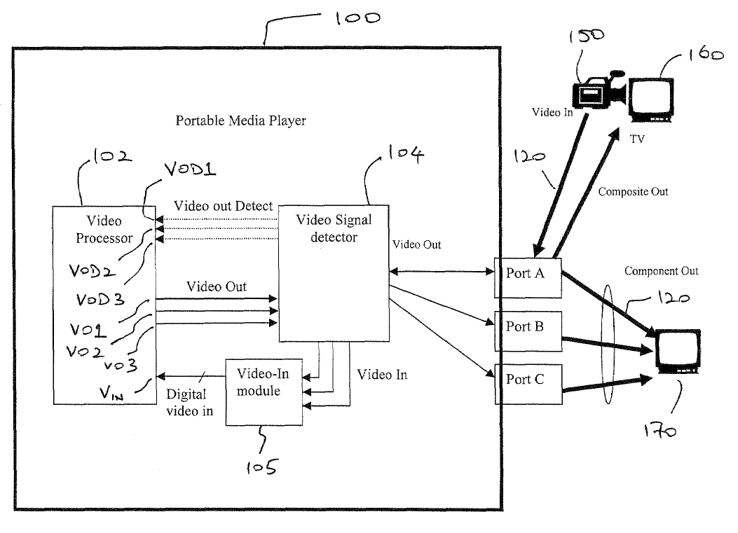

FIG. 1 is a block diagram illustrating relevant components of a portable media player 100 according to an embodiment of the invention. The portable media player includes a video processor 102 for generating video signals, three video ports A,B,C for inputting/outputting video signals and a video signal detector 104 coupling the video processor 102 to the video ports A,B,C. The input of video signals may be for the recording of video content. As shown in FIG. 1, the video ports A,B,C are used to connect the media player to different display devices such as a camcorder 150 or televisions 160,170.

In this embodiment, the video processor 102 is capable of generating three different types of video signals namely composite video, S-video and component video, and these are output via the processor's video-out ports VO1, VO2, VO3 to the video detector 104. The processor's detection inputs VOD1,VOD2,VOD3 are used to carry control signals from the video signal detector 104 to control which of the three video signal types the processor should output. In this embodiment, the video processor's GPIO ports are configured as the VOD1,VOD2,VOD3 inputs. The media player 100 also includes a video-in module 105 to channel input video signals to the video processor 102 at port VIN. The video-in module 105 is connected to the video signal detector 104 via VI1, VI2 and VI3 depending on which port the camcorder 150 is coupled to.

Each type of video signal requires a predetermined number of ports for transferring its video signals (for example, composite video: 1 port; s-video: 2 ports and component video: 3 ports) and conventionally, the video player needs to have dedicated video ports to output each of these video signal types resulting in a large number of video ports (to support the three signal types mentioned, twelve video ports are required).

In contrast, the present embodiment of the invention requires only three video ports A,B,C to support the three different types of video signals, and how this is achieved will be elaborated further below.

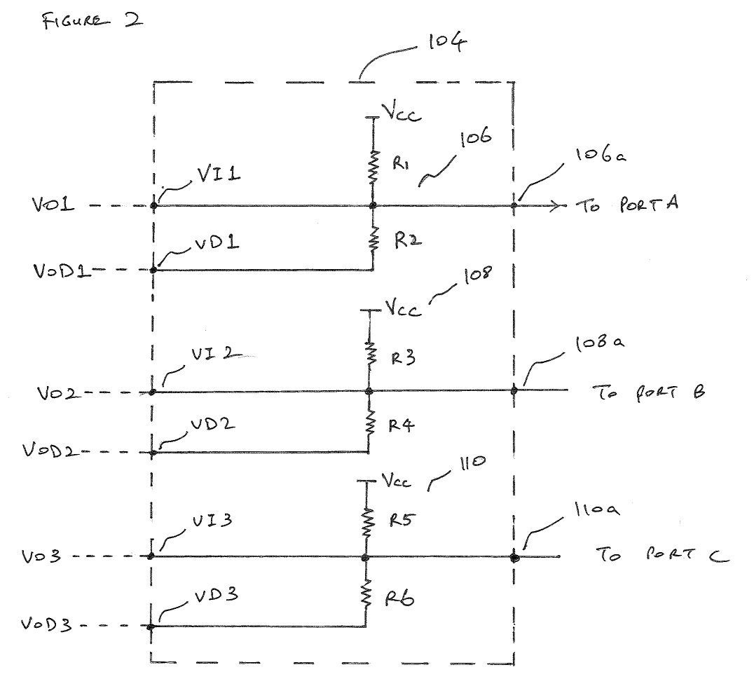

FIG. 2 is a schematic diagram of the video signal detector 104 of FIG. 1 which includes three identical voltage divider circuits 106,108,110. Outputs 106a,108a,110a of the divider circuits are each connected to respective video ports A,B,C. The divider circuits have inputs VI1, VI2 and VI3 and these are connected to respective VO1, VO2 and VO3 outputs of the video processor whereas VD1, VD2 and VD3 terminals of the circuit 104 are coupled to the VOD1/2/3 inputs of the processor 102.

With the voltage divider arrangement, the VD1, VD2 and VD3 terminals of the video detector 104 are normally “high”. However, when a load, and in this embodiment a cable 120 connected to a display device, is connected to the video ports, for example video port A, this pulls the voltage at VD1 “low” since a typical display device, such as, for example, a television 160, has a 75 ohms impedance. Consequently, if a “high” is detected at VD1,VD2 and VD3, then no connection to a display device is present whereas a “low” represents that a display device is connected to the corresponding port. Based on this, the detector 104 can determine the number of video ports that are being used and the signal levels at VD1, VD2 and VD3 are communicated to VOD1, VOD2 and VOD3 of the video processor 102. For example, if predefined settings designate port A for composite video, then port A is for detecting composite video. Correspondingly, ports A & B may be defined for s-video, and since port A is already used to detect composite video, port B is designated to detect s-video. Once port B detects connection to a display device & port C is not utilized (i.e. no load is coupled thereto), s-video mode is generated with no necessity to check port A. The same concept applies for component video out, such that if port C detects connection to a display device, component video out mode is activated with no necessity to check ports A and B. The resultant mode is detected by the corresponding VOD1/2/3 input of the video processor 102. The video processor 102 then generates the appropriate output via one of VO1/2/3 outputs and the video signals are delivered to Port A/B/C via the respective VI1/2/3 input of the detector 104.

The detection and generation of the correct video format is possible because the number of utilised ports for each video format is different.

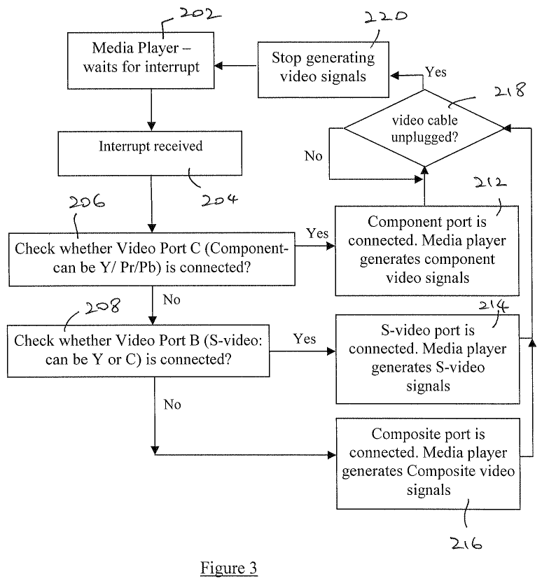

FIG. 3 shows how the above detection and generation process is carried out by the media player 100 and in this case, an interrupt routine is used to inform the player of the type of video selected. At step 202, when the media player 100 is not interrupted, it is performing other functions as instructed by the user. The interrupt routine is initiated when a cable connected to a display device is connected to any of the video ports A, B or C and when an interrupt is received at step 204, the media player 100 proceeds to detect which of the video ports A,B,C are being used starting at step 206, which checks whether Port C is connected. If so, the media player 100 proceeds to generate component video signals at step 212.

If Port C is not connected, then the media player checks the voltage level at VOD2 for Port B at step 208 and if it is “low”, the media player knows that Port B is connected and proceeds to generate s-video signals via Ports A and B at step 214.

However, if Port B is not connected, the media player knows that video port A is connected (since the interrupt routine is initiated, at least one port must be connected), and proceeds to generate composite video via port A at step 216.

During playback (i.e. the media player is outputting the selected video signals), the media player also incorporates a self-check routine at step 218. If any of the connected cables is subsequently disconnected from the video ports A, B or C, the video player detects this (since any disconnection will be detected by the detector circuit 104 which changes the corresponding voltage level at VOD1, VOD2 and VOD3 back to “high”), and the video processor 102 stops the output of the video signals at step 220 and goes back into detection mode to detect which of the ports are being used.

With the used of the detection circuit, it is apparent that the video port count is reduced significantly since the video signals are shared between the ports in the following manner:

### Video Port A: Composite/S-video (Y)/Component (Y)

### Video Port B: S-video (C)/Component Pb

### Video Port C: Component Pr

It would be appreciated that other permutations for sharing video signals among the video ports are envisaged, a further example of which is provided here:

### Video Port A: Composite/S-video (C)/Component (Pr)

### Video Port B: S-video (Y)/Component (Pb)

### Video Port C: Component Y

Each video port (A, B, C) can be configured as VIDEO IN or OUT accordingly. For example video port A can be configured as Composite Out/Composite In/S-video(Y) In/S-video(Y) Out/Component (Y) Out or Component(Y) In. Consequently, the video ports are shared between the different video signal types and thus, at least one of the video ports is arranged to selectively transfer two or more different video signal types. In other words, it would be appreciated that composite video signal may be mapped to any of the video port A, B or C; s-video's Y, C signal may be mapped to video port A, B or C; and component's Y, Pb, Pr signals may be mapped to video port A, B or C.

The described embodiment should not be construed to be limitative. For example, instead of using resistor arrangements to form the voltage divider circuits, logic gates can similarly be used to detect whether a cable is connected to the video ports A, B or C. No resistor values are provided in the resistor arrangement of FIG. 2 since these can be easily derived from a skilled person in the art, depending on the application. Of course, the detector 104 can also be used to detect other video signal types and not limited to just the three video signal types discussed in the described embodiment.

The video ports can be in any suitable form depending on the hardware requirements. For example, known RCA connectors can be used for each of the video ports but it is envisaged that all the video ports can also be incorporated in a connector similar to that used as a docking connector in Creative™ Vision:M's multimedia player, to save further space. The connector may be either a proprietary design or a standard catalogue item from a connector vendor. If such a connector is used, then the detector 104 may not be detecting presence of a cable connected to a display device coupled to the video port as an indication of whether there is a load. Instead, the detector 104 may be arranged to detect other forms of load. Even if the connector is not a standard TV cable, there may be a dongle/adaptor to enable connection to the connector. In this regard, the basic operation/detection process still follows FIG. 2.

With the present idea, it is possible to adapt the media player according to the video signal type that is being offered. For example, if a media player is capable of generating two different types of video signals, example, composite and s-video, then it is necessary only to equipped the media player with just two video ports since these ports are shared between the video signals. If, on the other hand, a media player is configured to offer more video signal types, then the video ports should be changed accordingly.

1. A circuit for determining which type of video signal is to be generated by a media player having a plurality of video ports for transferring different types of video signals, each type of video signal requiring a predetermined number of port(s) for transferring its video signal, the circuit comprising
a detector arranged to detect which of the video port(s) has a load coupled thereto, and is further arranged to control the media player to generate a said type of video signal according to the number of video port(s) detected that is coupled with said load.

2. A circuit according to claim 1, wherein the detector is arranged to detect connection of a display device to a said video port as an indication that a said video port has a load.

3. A circuit according to claim 1, wherein the detector comprises a plurality of voltage divider circuits with each divider circuit arranged to be coupled to a said video port to detect whether a load is coupled to a said video port.

4. A circuit according to claim 3, wherein the plurality of voltage divider circuits are arranged to be coupled to GPIO ports of a video processor to control which type of video signal is to be generated.

5. A media player comprising a circuit according to claim 1.

6. A media player according to claim 5, wherein the media player is capable of generating at least two video signal types selected from: composite video, s-video and component video.

7. A method of determining which type of video signals to be generated by a media player having a plurality of video ports for transferring different types of video signals, each type of video signal requiring a predetermined number of video port(s) for transferring its video signals, the method comprising:
detecting the number of video port(s) that has a load coupled thereto; and
controlling the media player to generate a said type of video signal according to the number of video port(s) detected that is coupled with said load.

8. A method according to claim 7, further comprising detecting connection of a display device to a said video port as an indication that a said video port has a load.

9. A media player capable of generating different video signal types, the media player comprising a plurality of video ports arranged to transfer the different types of video signals, each type of video signal requiring a predetermined number of ports for transferring its video signals, wherein at least one of the video port is arranged to selectively transfer two or more different video signal types.

10. A media player according to claim 9, wherein the media player is capable of generating at least two video signal types selected from: composite video, s-video and component video.

11. A system for determining which type of video signal is to be generated by a media player having a plurality of video ports for transferring different types of video signals, each type of video signal requiring a predetermined number of video port(s) for transferring its video signal, the system comprising
a detector arranged to detect which of the video port(s) has a load coupled thereto, and is further arranged to control the media player to generate a said type of video signal according to the number of video port(s) detected that is coupled with said load.

12. A system according to claim 11, wherein the detector is arranged to detect connection of a display device to a said video port as an indication that a said video port has a load.

13. A system according to claim 11, wherein the detector comprises a plurality of voltage divider circuits with each divider circuit arranged to be coupled to a said video port to detect whether a load is coupled to a said video port.

14. A system according to claim 13, wherein the plurality of voltage divider circuits are arranged to be coupled to GPIO ports of a video processor to control which type of video signal is to be generated.
